(19) United States
(12) Patent Application Publication
(10) Pub. No.: US 2014/0278787 A1
(43) Pub. Date: Sep. 18, 2014

(54) SYSTEMS AND METHODS FOR GENERATING CUSTOMIZED, INDIVIDUALIZED COMMUNICATIONS

(71) Applicant: Maritz Holdings Inc., Fenton, MO (US)

(72) Inventors: Lorenzo Introna, Niedernhausen (DE); Christoph Stolz, Wiesbaden (DE); Thomas Ewen, Eppstein (DE); Christian Pfaff, Niedernhausen (DE)

(73) Assignee: Maritz Holdings Inc., Fenton, MO (US)

(21) Appl. No.: 14/205,804

(22) Filed: Mar. 12, 2014

Related U.S. Application Data
(60) Provisional application No. 61/790,240, filed on Mar. 15, 2013.

(51) Int. Cl. G06Q 30/02

(52) U.S. Cl. CPC G06Q 30/0203
USPC 705/7.32

(57) ABSTRACT

Customized, individualized communications to persons are generated based on a person's data available to a client instituting the systems and methods, based on previous data provided by the person in response to other contacts, based on product/services data of products/services purchased or used by the person, and based on personal data from transactions. The communications are based on such data within the context of marketing intervention parameters suggested by such data.

### CROSS-REFERENCE TO RELATED APPLICATIONS

This application is a nonprovisional patent application which claims the benefit of U.S. Provisional Patent Application Ser. No. 61/790,240 filed Mar. 15, 2013, the entire disclosure of which is incorporated by reference.

### BACKGROUND

The present invention generally relates to computer systems and methods for dialoguing with persons of interest on a variety of topics, including a product, service or brand.

Historically, survey research was a one-way conversation with the respondent simply answering a set of questions pertaining to a topic. Likewise, non-survey (e.g., marketing, etc.) communications were also one-way communications with one entity (the company/organization) sending messages to a second entity (the consumer). Comparatively, in-person human conversation is a give-and-take, back and forth activity between two parties. There is a need for automated systems and methods that mimic the give-and-take, back-and-forth of natural conversation.

### SUMMARY

In one form, a system for use by a client to obtain information from persons of interest is provided. The system includes a person of interest (POI) database of facts relating to each POI of the client, and a lifecycle database of various lifecycles of a plurality of POIs, a plurality of products and a plurality of services. Each lifecycle is defined by and includes one or more facts. The system also includes an intervention fragments database of fragments of communication content elements. An intervention (e.g., involvement) engine includes computer executable instructions stored on a tangible, non-transitory memory device and executed by a processor. The instructions evaluate the facts in the POI database and the lifecycles in the lifecycle database to identify fragments in the intervention fragments database to form a customized, individualized communication (e.g., intervention) to be provided to a specific POI, which customized, individualized communication is related to the facts of the POI and the lifecycle(s) which relate to the POI. A schedule engine selectively initiates a point in time to provide the customized individualized communication to the specific POI based on the evaluation by the intervention engine.

A computer executable method executable by a processor for use by a client to obtain information from persons of interest is also provided.

### BRIEF DESCRIPTION OF THE DRAWINGS

FIG. 1 is a block diagram of an overview of the lifecycle and intervention (e.g., involvement) control engine according to aspects of the invention.

FIG. 2 is a block diagram of an overview of the Customer History Data Management Module according to aspects of the invention.

FIG. 3 is a block diagram of an overview of the Intelligent Fragment Selection and Assembly Module according to aspects of the invention.

FIG. 4 is a block diagram of an overview of the Intervention Control Module according to aspects of the invention.

FIGS. 5-7 are exemplary screen shots illustrating aspects of the Customer Data Management Module according to aspects of the invention, illustrating the fact types tab 101.

FIGS. 8-20 are exemplary screen shots illustrating aspects of the Intelligent Fragment Selection and Assembly Module according to aspects of the invention. FIGS. 8-10 illustrate the life cycle definitions tab 201. FIGS. 11-13 illustrate the intervention fragments tab 204. FIG. 14 illustrates the intervention trigger rules tab 205. FIGS. 15-19 illustrate the intervention assembler rules tab 207. FIG. 20 illustrates the watchdogs tab 210.

FIG. 21 is an exemplary screen shots illustrating aspects of the Processing Settings Database according to aspects of the invention, illustrating the general processing settings tab 700.

### DETAILED DESCRIPTION

In one form, systems, methods and computer executable instructions generate customized, individualized communications (e.g., intervention) to persons based on data relating to a person of interest (POI) available to a client instituting the communications, based on previous data provided by the POI in response to other contacts, based on product/services data of products/services purchased or used by the POI, and based on personal data from transactions relating to the POI and/or products or services connected to the POI. The communications are based on such data within the context of marketing intervention parameters (e.g., involvement parameters) suggested by such data.

The system automates an ongoing, individualized dialogue between two parties (e.g., the POI and the client). The system analyzes known information about persons of interest, identifies each person of interest according to certain criteria, and distributes individualized communications to each person of interest. The communication distributed may include a combination of survey and marketing (or other) content, and each recipient will receive an individualized communication. The system combines both survey content and other content into a single, customized communication

The communication building mechanism represents an advancement in survey research. Historically, survey research questionnaires were crafted to answer a point-in-time set of questions about a product, service, brand, etc. A list of potential respondents (called the sample list) would all receive the same questionnaire. The questionnaire may include variable content but the variability would be limited (if A=1, answer question 5, etc.) and parsed out to groups of respondents. The systems and methods serve up an individualized survey communication based on a plurality of data points tested against a plurality of business rules instructions executed the system that direct the inclusion and ordering of survey content. Rather than having intelligence within the survey itself—the decision of what has to be included in a communication to a person of interest is determined before the communication is sent to the person of interest.

In addition, the systems and methods continuously monitor to maintain an ongoing relationship with each individual person of interest. This is achieved through facts. Facts are any piece of information available to the systems and methods about the relationship of a person of interest and the surrounding environment of the client instituting the communications. This could be for example a purchase or service event. It could also be a birthday, or change in the family status. Facts are used to maintain lifecycles that depict the reality of the person of interest and therefore the context of the relationship between the person of interest and the client instituting the communications. Additional facts and other changes in the person of interest's data initiate a process that cycles through all known customer data to pinpoint changes in the state of the person's history data and then recalculates (e.g., determines) and updates the person's lifecycles based on these changes. Lifecycles represent the relationships between the person of interest, supplier, product, and sales or service provider.

Through the use of so-called trigger rules, lifecycle assignments and facts about the person of interest combine to define the intervention fragments (e.g., involvement fragments) to be contained in future interventions with the person of interest. Interventions consist of one or more intervention fragments, and based on intervention assembler rules, are assembled and scheduled for future contact.

The systems and methods run autonomously without input from external sources. This is possible because the feedback provided by persons of interest can be used to generate future interventions and so can run for an indefinite period of time. At each processing point, the system will review all known data about a person of interest, match the person's data to the lifecycle facts and then match the lifecycle facts to the intervention fragments. Intervention fragments are then evaluated against configured business rules, selected for inclusion and ordered into an individualized communication (e.g., intervention) for each person of interest. The system is designed to collect feedback and send messages as dictated by the known information and will continue to do so until the person's data no longer meets the guidelines for any of the lifecycles and intervention fragments (e.g., the relevant lifecycles have been terminated).

The following description refers to systems and methods (e.g., processes). As used herein, systems include the methods implemented by the systems and methods include systems which implement the methods. Most methods are implemented by computer executable instructions. For convenience, the methods are not always described in the context of computer executable instructions. It is contemplated that any and all methods herein are implemented by such instructions. The systems and methods relate to communications instituted by a client with a person of interest. Communications include but are not limited to questionnaires, surveys, marketing contacts, phone contacts and other interactions with a person of interest. For exemplary purposes, the following description illustrates the systems and methods in the context of questionnaires and survey. It is contemplated that such references to questionnaires and surveys are exemplary and that any communication or interaction may replace the questionnaires and surveys noted herein, without departing from the scope of the systems and methods of the invention.

FIG. 1 is a block diagram of an overview of the lifecycle and intervention (e.g., involvement) control engine according to aspects of the invention. In one form, systems and methods collect and process data as follows. Data about each person of interest is provided to the system via an API or in the form of a file, which can be read by a converter. Once imported, data is validated in terms of quality and optionally enriched. An address matching process matches new data to existing data already housed in the system.

During each processing cycle:
a. Data about each person of interest is analyzed against pre-configured rules to create, modify and/or delete one or more so called lifecycles for each person of interest. Lifecycles are used to reflect relationships between the person of interest, supplier, product, and sales or service provider.
b. Each lifecycle is associated with a set of Intervention Trigger Rules. Intervention Trigger Rules are processed by the Intervention Trigger Rules Processer to generate a disorganized list of potential Intervention fragments. Intervention fragments are artifacts that are used in later processing steps to collectively build dynamic content for each individual person of interest.
c. The Intervention Assembler Processer organizes (sorts, eliminates conflicts, prioritizes, etc.) and assembles the generated list of Intervention fragments according to configured Intervention Assembler Rules. The result is a set of one or more individualized combinations of one or more assembled Intervention fragments. Each individualized combination is called an Intervention, and each Intervention is planned for a future point in time.
d. The Watchdog Processor reviews all scheduled Interventions against a configured set of Watchdog Rules. Watchdog Rules dictate business requirements for interventions. For example, a Watchdog Rule may dictate that only a certain number of people receive Intervention Fragment X. If too many are scheduled, the Watchdog rule will identify the error and remove Intervention Fragment X from as many individual Interventions as necessary in order for the scheduled interventions to be in compliance with the Watchdog Rule.

After the Intervention passes the Watchdog Processing, it is queued up and ready to be distributed.

For the distribution of the interventions, the Intervention Schedule Control passes scheduled interventions to the Intervention Control Data where it is processed further by the Intervention Steering and Sample Control.

All the previous steps are managed in processing cycles. The cycles are configured to run at specific times based on the requirements of the system owner. There are also some instances where process cycles are triggered by external events, for example, a processing cycle may be initiated by the receipt of new data from an external system which updates the Customer History Data.

If the intervention includes a request to the person of interest for feedback, any data collected by the system is returned to the Customer History Data Management module.

### Components

Depending on the implementation, systems and method employ some or all of the following components:
Facts
Lifecycles
Intervention Triggers
Intervention Assembler
Intervention Watchdogs
Interventions
Schedule Control

The purposes of these components are detailed in the following sections below.

Business rules are part of the business rules framework applied the systems and methods, depending on implementation. The rules include some or all of:
Lifecycle Rules
   Rules to initiate a lifecycle, for example when fact “ABC” is found in the system for the POI then initiate a lifecycle for the POI
   Rules that maintain a lifecycle, for example when fact “PQR” is found in the system for the POI, update a defined lifecycle for the POI
   Rules that terminate a lifecycle, for example when fact “XYZ” is found in the system for the POI, terminate a define lifecycle for the POI
Intervention Trigger Rules
   Rules that determine an intervention based on POI personal data, for example, if the POI has a birthday in 5 days time then extract a birthday wish fragment
   Rules that determine an intervention based on facts about a POI, for example, if the fact “ABC” occurred in the last 14 days then extract a fragment to send a thank you message
   Rules that determine an intervention based on calculated POI data, for example, if the Loyalty Score is lower than 75 then extract a fragment to send an offer to the POI
Intervention Assembler Rules
   Rules that determine the final structure of an intervention based on Compatibility, for example, fragments “ABC” and “XYZ” are allowed to be merged together in a single communication, whereas fragments “ABC” and “PQR” are not, therefore always separate them
   Rules that determine the final structure of an intervention based on Priority, for example, if a decision needs to be made on which fragment to send to the POI, the one with the highest priority will be selected first
   Rules that determine the final structure of an intervention based on Order, for example, if more than one fragment exists for an intervention the order rules will decide in which order they appear in the fragment
Watchdog Rules
   Rules that determine the final structure of an intervention based on Budget, for example, check all fragments “XYZ” in outgoing interventions and remove them if a specific budget limit has been reached
   Rules that determine the final structure of an intervention based on Volume, for example, check all fragments “XYZ” in outgoing interventions and remove them if a specific number have already been sent out
   Rules that determine the final structure of an intervention based on Significance, for example, check all fragments “XYZ” in outgoing interventions and remove them if statistical significance has already been achieved with previous answers for a specific question

The purposes of these rules are detailed in the following sections below.

### 100. Customer History Data Management Module

FIG. 2 is a block diagram of an overview of the Customer History Data Management Module 100 according to aspects of the invention. FIGS. 5-7 are exemplary screen shots illustrating aspects of the Customer Data Management Module according to aspects of the invention, illustrating the fact types tab 101. Systems and methods described herein house a plurality of data elements, called “facts,” about each person of interest. Data elements originate from outside and from within the system. Externally generated data points are transferred to the system via application programming interfaces (APIs) or by file, which can be read by a converter. Imported data—that data is externally generated or originates externally—is validated, enriched as needed and matched to existing records by an address checking process. In FIG. 5, the details tab receives input to regarding the fact type id, name and remark. In FIG. 6, the attributes tab indicates name, type, field and actions. In FIG. 7, the associations tab connects to other entities, role types, cardinalities, roles and actions.

Systems and methods described herein combine multiple types of data about each person of interest. Standard data types include one or more of the following.

Personal Contact Data: name, address, phone numbers, email addresses, contact preference selections, demographics, etc.

Product Data: Sales and transaction histories pertaining to person of interest and their purchase of products or services from the sponsoring company. Data points could include date of purchase/use, location of purchase/use, descriptions of purchase/use, etc.

Financial Data: Transactions, revenue, profitability and other financial data pertaining to each person's purchase of products or services from the sponsoring company. For example, an insurance company installation may also note what types of discounts have been provided to the person of interest (e.g., multi-vehicle discounts, safe driver discounts, etc.).

Relationship Data Summarizes the relationship between each person of interest and the supplier, product, and sales or service provider. For example, relationship data could indicate that the person of interest is a frequent customer of a certain hotel and certain hotel brand. The relationship data could also indicate a depth of relationship, such as a reward status level (e.g., Platinum flyer).

Attitudinal Data: Known attitudes possessed by the person of interest. Sources may include prior responses to survey questions, either coming from external systems or internal from the systems and methods.

All of the above types of data could originate from a variety of systems already deployed (externally generated). For example, an automotive dealer's customer relationship system may provide personal contact data, product data and relationship data. The dealer's financial reporting system may store transactional financial data and the corporation's customer database may store the attitudinal data. The systems and methods would receive data from each of these separate systems via an API or file transfer.

The systems also house a plurality of data elements that originate from within the system. Personal Contact Data, Relationship Data, and Attitudinal Data could originate from within the systems and methods. Once a person of interest provides an input (i.e., by answering a survey question), those answers are stored and added to the consumer database. The Customer History Data Management function may be configured to adjust for specific project needs by adjusting or adding so called plugins based on the project needs. An example of specific project or client needs could be a validation algorithm that is not commonly available which needs to validate serialized data provided by the client. The validation algorithm may be implemented for a specific project using a plugin which is specially constructed for the client's needs.

### 200. Intelligent Fragment Selection and Assembly Module

FIG. 3 is a block diagram of an overview of the Intelligent Fragment Selection and Assembly Module 200 according to aspects of the invention. The Intelligent Fragment Selection and Assembly Module manages lifecycles for each person of interest, matches facts on the lifecycle to Intervention fragments according to intervention trigger rules, and assembles the communications (called Interventions) for persons of interest. FIGS. 8-20 are exemplary screen shots illustrating aspects of the Intelligent Fragment Selection and Assembly Module according to aspects of the invention.

### 201. Lifecycle Data

FIGS. 8-10 illustrate the life cycle data 201 definitions tab 201. System houses a plurality of “lifecycle definitions.” Lifecycles are specified to depict the relationships between the person of interest, supplier, product, and sales or service provider. Each person of interest has at least one, and perhaps multiple, lifecycles depending on the “facts” housed in the Customer History Data Management module.

### 202. Lifecycle Rules

For each lifecycle rule 202, we define what initiating fact signals (see FIG. 8, initiating facts tab) that a lifecycle has begun, what fact will modify or enrich the lifecycle (see FIG. 9, lifetime facts tab), and what facts would indicate a termination of the lifecycle (see FIG. 10, terminating facts tab). For example, an initiating fact may be that a person buys a certain product. A fact that modifies the lifecycle may be the service visit for the product, and a terminating fact may be that the product was sold.

### 203. Lifecycle Creator

The Lifecycle Creator 203 cycles through all Customer History Data to detect all “facts” for a specific person of interest. If an initiating “fact” is detected within the Customer History Data, the system will create the defined lifecycle for that person if it does not already exist. In the same way, facts within the Customer History Data are also analyzed to see whether they modify or enrich the lifecycle or terminate the lifecycle.

### 204. Intervention Fragment Data

FIGS. 11-13 illustrate the intervention fragments data tab 204. System houses a plurality of communication content elements, called “intervention fragments.” These fragments may include questions that we wish to ask of the persons of interest or messages that we wish to share with the persons of interest. Fragments may be very specific and for a certain purpose, like a specific offer, or more general like a common set of questions that are asked at each intervention. Multiple fragments may be combined into a single communication for each person of interest and stored in the Intervention Fragment Data. As shown in FIGS. 11-13, the fragments include fragment details, fragment variants, and fragment dependencies.

### 205. Intervention Trigger Rules

FIG. 14 illustrates the intervention trigger rules tab 205. System houses a plurality of rules called Intervention Trigger Rules, which determine the extraction of intervention fragments for lifecycles of persons of interest. The assignments of Intervention fragments are based on the specific Lifecycle used for each person of interest. Each lifecycle depicts the relationships that a person of interest has and therefore ensures that the interventions are carried out in the context of the relationship. This is required to ensure the relevancy of an intervention for the person of interest.

### 206. Intervention Trigger Rule Processor

The Intervention Trigger Rule Processor 206 cycles through the lifecycle assignments and other customer data, housed in the Customer History Data Module in order to prescribe a disorganized list of Intervention fragments appropriate for distribution to each person of interest.

### 207. Intervention Assembler Rules

FIGS. 15-19 illustrate the intervention assembler rules tab 207. System houses a plurality of rules to direct the assembling of multiple Intervention fragments into a single communication. These configurable rules organize the list of Intervention fragments into a ready-to-distribute Intervention. Rules may dictate, for example, that certain Intervention fragments may not be combined. When multiple Intervention fragments are prescribed, these rules dictate the priority of inclusion. As shown in FIGS. 15-19, the rules include one or more of matching rules, order rules, overkill rules, channel rules, and triggergraph indexing.

For example, if Intervention A and B cannot be combined, an Intervention Assembler Rule would dictate which of the two Intervention fragments would be included. The Intervention Assembler Rules database also includes rules directing the order of Intervention fragments. For example, if a communication is to include Intervention fragments A, C and G, an Intervention Assembler Rule may indicate that A is always first and a second Intervention Assembler Rule may indicate that G always occurs before C.

### 208. Intervention Assembler

The Intervention Assembler reviews the disorganized list of Intervention fragments produced by the Intervention Trigger Rule Processor against the configured Intervention Assembler Rules. The Intervention Assembler then sorts, eliminates conflicts and orders the Intervention fragments into so-called Interventions. Finally the interventions are scheduled for processing at a future point in time.

### 209. Intervention Schedule Data

All scheduled interventions and the related data for final processing are stored in the Intervention Schedule Data. This does not represent a final state as through the processing of the next steps (210 and 211) the individual fragments in an intervention may be modified again.

### 210. Watchdog Rules

FIG. 20 illustrates the watchdog rules tab 210. System houses a plurality of business rules that finalize Intervention content. The configured Watchdog Rules let the sponsoring organization set limits on the number of certain Intervention fragments distributed to persons of interest. For example, a Watchdog Rule could pertain to budget. Distributing Intervention Fragment A costs $1 and the company limits the monthly spend on Intervention Fragment A to $15. Once 15 people have received Intervention Fragment A, any additional Interventions prescribed during that month that include Fragment A would be revised to eliminate said Fragment.

### 211. Watchdog Processor

The Watchdog Processor 211 reviews the Interventions that are scheduled against the configured Watchdog Rules. Intervention fragments are eliminated as needed to conform to the Watchdog Rules.

### 300. Intervention Control Module

FIG. 4 is a block diagram of an overview of the Intervention Control Module 300 according to aspects of the invention. The Intervention Control module 300 ensures the proper processing of the scheduled interventions. It maintains the interface with external system and processes not directly linked to the systems and methods.

### 301. Intervention Schedule Control

The Intervention Schedule Control 301 is activated at pre-defined times to process the Intervention Schedule Data. All data marked as ready to be processed will be prepared for transfer to an external system. The external system can be a data collection system like Online Survey, a Call Center, a 1-2-1 Agency, etc. depending on the type of intervention and distribution method for the intervention.

### 302. Customer Information and

### 303. Intervention Export

The main focus of the preparation for transfer to an external system is to gather all necessary customer information data 302 needed for processing in the external system. This includes the applicable customer data as well as the physical intervention data needed by the external system. Once a transfer (intervention export 303) has been completed all interventions are placed into a wait status pending feedback from the external system.

### 304. Intervention Import

Answers gathered from persons of interest from the external system can result in three possible statuses. The most obvious and desired is that the Intervention has been completed. The second is that the Intervention is still in progress. The third state is that the intervention has timed out, meaning it cannot be processed or accepted anymore and will be classified as incomplete.

All answers gathered from persons of interest are finally stored in the customer history data by an intervention import 304. As already described, updates to the customer history data reinitiate the calculation process described here again based on the feedback provided.

### 700. Processing Settings Database

FIG. 21 is an exemplary screen shots illustrating aspects of the Processing Settings Database 700 according to aspects of the invention, illustrating the general processing settings tab 700. The overall control of the entire process is managed by additional parameters that control the processing.

### 701. Planning Period

In the above mentioned processes, it has frequently been mentioned that interventions are planned for a future planning period 701 in time. This is required to limit the number of calculations required, and the time needed to perform them. This parameter sets the time period in days. For example, two weeks would be 14 days, six months would be 180 days, etc.

### 702. Flag Out Period

Before the final processing of an intervention, it may be desired to provide manual control to the system user, enabling the system user to manually remove interventions, or parts of interventions (fragments), from the process. This is done with a flag out function 702. This parameter defines the number of days before an intervention will be carried out and will be shown in the manual flag out function.

### 703. Blocking Period

It is necessary to stabilize the calculation process to ensure that there is not constant movement, which in turn prevents interventions. This parameter sets the number of days (blocking period 703) before an intervention will take place so that it remains frozen and is not able to be changed anymore.

### 704. Overkill Iterations Maximum Count

In the ordering of the intervention fragments into assembled interventions, multiple calculations are done to ensure that the best performing interventions are created. These calculations can potentially be never-ending so a maximum count can be defined by an overkill interactions maximum count 704 to prevent endless calculation loops.

### First Illustration: In Action for a Hotel Company

This system is unique in the combination and uses of the data in order to create personalized, individualized surveys and communications (called Interventions). In existing systems, one or two pieces of data might be combined in order to create limited, segmented communications. In this system, many more data pieces are combined in unique combinations to create an individualized approach. Example embodiment: Great Hotel Company uses the system to create an ongoing dialogue with its customers/guests. For example, the Customer Data History module has the following data “facts” about a certain person of interest:
Name: John Stone
Male
Age 42
Business traveler
Platinum rewards card holder (highest level)
Resides in Birmingham, Mich.
Married
Two children
Stayed 8 times in past 12 months, 16 total nights at Anytime Hotel in St. Louis, Mo.
Stayed 4 times in past 12 months, 10 total nights at Conference Plus Hotel in St. Louis, Mo.
Stayed 3 times in past 12 months, 8 total nights at Anytime Hotel in Los Angeles, Calif.
Stayed 4 times in past 12 months, 4 total nights at Anytime Hotel in Chicago, Ill.
Stayed 1 time in past 12 months, 13 total nights at Family Plus Hotel in Orlando, Fla.
It has been 125 days since John Stone has stayed at the Anytime Hotel in St. Louis, Mo.
It has been 42 days since John Stone has stayed at the Conference Plus Hotel in St. Louis, Mo.
It has been 68 days since John Stone has stayed at any location of Anytime Hotel
Purchased breakfast 10 times at the Anytime Hotel in St. Louis, Mo.
Purchased dinner 2 times at the Family Plus Hotel
Prior survey answers indicate that the reasons for trips to St. Louis and Chicago are most frequently business
Prior survey answers indicate that John Stone chooses Anytime Hotel 70% of the time when he travels for business
Prior survey answers indicate that John Stone stays in a hotel more than 60 days annually for business travel and more than 10 days annually for leisure travel
Anytime Hotel, Conference Plus Hotel and Family Plus Hotel are all owned by Great Hotel Company
All Anytime Hotel locations have a similar design and layout
All Anytime Hotel locations are in suburbs of major cities

Great Hotel Company (i.e., the client instituting the communications) deploys the system and method in order to create an ongoing dialogue with its customers, including John Stone. The system includes a plurality of rules governing the assignment of lifecycles to each person of interest, such as John Stone. Each rule uses one or more data facts to assign persons to lifecycles. For example:
Persons who have stayed at any of The Great Hotel Company hotels are identified as Great Hotel Company Customers.
Persons who have stayed at any of the Anytime Hotel locations are identified as Anytime Customers.
Persons who have stayed at the Anytime Hotel location in St. Louis are identified as Anytime St. Louis Customers.
Persons who have stayed at the Anytime Hotel location in Chicago are identified as Anytime Chicago Customers.
Persons who have stayed at the Anytime Hotel location in Los Angeles are identified as Anytime Los Angeles Customers.
Persons who have stayed at any of the Family Plus Hotel locations are identified as Family Plus Customers.
Persons who have stayed at the Family Plus Hotel in Orlando are identified as Family Plus Orlando Customers.
Persons who have stayed at any Conference Plus Hotel locations are identified as Conference Plus Customers.
Persons who have stayed at the Conference Plus Hotel in St. Louis are identified as Conference Plus St. Louis Customers.
Persons who have signed up for the rewards program are identified as Rewards Member Customers.

Each lifecycle is connected to certain Intervention Fragments. Intervention Fragments are prescribed automatically based on a combination of Lifecycle assignments and other “facts” known about the individual. For example, the following Intervention Fragments are prescribed for John Stone based on his lifecycle assignments and other facts:

A 5-question survey to learn why the individual has stopped staying at the St. Louis Anytime Hotel location is prescribed. This is prescribed because John Stone's customer “facts” meet the following Intervention Trigger rules:
a. Anytime Hotel Customer,
b. Anytime St. Louis Customer,
c. Stayed at Anytime St. Louis more than 5 separate occasions in the past 12 months
d. Has not stayed at the Anytime St. Louis location in more than 90 days.

A 3-question survey to learn how Anytime Hotel Company compares to its two largest rivals is prescribed. This is prescribed because John Stone's customer “facts” meet the following Intervention Trigger rules:
a. Anytime Hotel Customer,
b. Platinum Rewards Member,
c. Stayed at an Anytime location 30 or more total room nights in last 12 months
d. Has not stayed at any Anytime Hotel location in more than 60 days

A coupon for a free executive breakfast buffet at any Anytime Hotel location is prescribed. This is prescribed because John Stone's customer “facts” meet the following Intervention Trigger Rules:
a. Anytime Hotel Customer, and
b. Transaction history/sales record of ordering breakfast

A monthly email about being a “Road Warrior” is prescribed. This is prescribed because John Stone's customer “facts” meet the following Intervention Trigger Rules:
a. Great Hotel Company Customer,
b. Male,
c. Business Traveler,
d. Rewards Member
e. Has children, and
f. Stays overnight in a hotel more than 60 days annually for business travel

The above four Intervention Fragments are identified as appropriate for John Stone. The disorganized list of Intervention Fragments is evaluated by the Assembler Processor and matched to Assembler Rules. Assembler Rules dictate that:
Intervention fragment No. 3 and No. 4 cannot be sent in the same communication.
Intervention Fragment No. 4 is prioritized above Intervention Fragment No. 3.
Intervention Fragment No. 1 is ordered before Intervention Fragment No. 2.
Intervention Fragment No. 4 is ordered last.

The Intervention Assembler Processor removes Intervention Fragment No. 3 from the generated list for John Stone and orders the remaining Intervention Fragments appropriately (Intervention Fragment No. 1 appears first, followed by Intervention Fragment No. 2, followed by Intervention Fragment No. 4). The ordered and prioritized list of Intervention Fragments is published as a finished Intervention.

The finished Intervention is reviewed by the system's Watchdog Rules processor, which matches the Intervention content against a set of configured business rules. One of the system's Watchdog Rules states that only 1,000 total Great Hotel Company Customers should answer Intervention No. 2. The system has received data from 747 completed surveys, so Intervention No. 2 for John Stone is permitted, as it conforms to the system's Watchdog Rules.

The Intervention for John Stone is finalized, scheduled and distributed via email.

Three days later, John Stone answers the 5-question survey about Anytime Hotel in St. Louis and the following new data points are received and stored by the Customer Data History module:
John Stone has traveled to St. Louis 3 times for a total of 8 room nights since he last stayed at the Anytime Hotel.
John Stone rated his most recent stay at the Anytime Hotel in St. Louis as a 1, meaning unsatisfactory.
John Stone provided the following comment about his last stay, “The room smelled like cigarette smoke and the bathroom was not properly cleaned.”
John Stone said he “most likely will not” stay again at Anytime Hotel in St. Louis.
John Stone also answers the 3-questions about how Anytime Hotel locations compared to its two biggest rivals. The following new data points are received and stored by the Customer Data History module:
John Stone said he believes that Anytime Hotel is a better choice for business travel than Neighborhood Hotel (one of the two rivals) but that Everyday Business Hotel (the second of the two rivals) is a better choice than Anytime Hotel. He provides the following comment, “While they have fewer locations, Everyday Business Hotel is much nicer than Anytime Hotel and for the same price.”
John Stone said he “most likely will” stay at Anytime Hotel locations in the future.
John Stone said he stays between 90 and 120 nights annually in a hotel for business.

Upon receipt of the new information, the system cycles through all known facts about John Stone and reviews the data facts about John Stone against the lifecycle rules. The lifecycle rules processor identifies John Stone as being a member of the following lifecycles:
Persons who have stayed at any of The Great Hotel Company hotels are identified as Great Hotel Company Customers
Persons who have stayed at any of the Anytime Hotel locations are identified as Anytime Customers
Persons who have stayed at the Anytime Hotel location in St. Louis are identified as Anytime St. Louis Customers
Persons who have stayed at the Anytime Hotel location in Chicago are identified as Anytime Chicago Customers
Persons who have stayed at the Anytime Hotel location in Los Angeles are identified as Anytime Los Angeles Customers
Persons who have stayed at any of the Family Plus Hotel locations are identified as Family Plus Customers
Persons who have stayed at the Family Plus Hotel in Orlando are identified as Family Plus Orlando Customers
Persons who have stayed at any Conference Plus Hotel locations are identified as Conference Plus Customers
Persons who have stayed at the Conference Plus Hotel in St. Louis are identified as Conference Plus St. Louis Customers
Persons who have signed up for the rewards program are identified as Rewards Member Customers

Each lifecycle is associated with certain Intervention Fragments. John Stone's lifecycle assignments result in the following list of Intervention Fragments being prescribed for him:

A 5-question survey to learn why the individual has stopped staying at the St. Louis Anytime Hotel location is prescribed. This is prescribed because John Stone's customer “facts” meet the following Intervention Trigger rules:
a. Anytime Hotel Customer,
b. Anytime St. Louis Customer,
c. Stayed at Anytime St. Louis more than 5 separate occasions in the past 12 months
d. Has not stayed at the Anytime St. Louis location in more than 90 days.

A 3-question survey to learn how Anytime Hotel Company compares to its two largest rivals is prescribed. This is prescribed because John Stone's customer “facts” meet the following Intervention Trigger rules:
a. Anytime Hotel Customer,
b. Platinum Rewards Member,
c. Stayed at an Anytime location 30 or more total room nights in last 12 months
d. Has not stayed at any Anytime Hotel location in more than 60 days

A coupon for a free executive breakfast buffet at any Anytime Hotel location is prescribed. This is prescribed because John Stone's customer “facts” meet the following Intervention Trigger Rules:
a. Anytime Hotel Customer, and
b. Transaction history/sales record of ordering breakfast

A monthly email about being a “Road Warrior” is prescribed. This is prescribed because John Stone's customer “facts” meet the following Intervention Trigger Rules:
a. Great Hotel Company Customer,
b. Male,
c. Business Traveler,
d. Rewards Member
e. Has children, and
f. Stays overnight in a hotel more than 60 days annually for business travel

A Free Night Stay coupon for use at any Anytime Hotel location, customized to family travelers is prescribed. This is prescribed because John Stone's customer “facts” meet the following Intervention Trigger Rules:
a. Great Hotel Company Customer
b. Platinum Rewards Member,
c. Stayed at an Anytime or Conference Plus location 30 or more total room nights in last 12 months,
d. Stayed at a Family Plus location for 3 or more room nights within the last 12 months,
e. Provided answers to 3-question survey about business travel

The Assembler Rules dictate the inclusion and ordering of Intervention Fragments. Rules dictate that:
Intervention No. 5 is ordered first.
Intervention fragment No. 3 and No. 4 cannot be sent in the same communication.
Intervention Fragment No. 4 is prioritized above Intervention Fragment No. 3.
Intervention fragment No. 3 and No. 5 cannot be sent in the same communication.
Intervention Fragment No. 5 is prioritized above Intervention Fragment No. 3.
Intervention Fragment No. 1 is ordered before Intervention Fragment No. 2.
Intervention Fragment No. 4 is ordered last.

Given the above rules, the Assembler Rule Processor sorts, eliminates as needed and orders the communication for sending to the person of interest. John Stone's communication is revised to include only Intervention Fragments 5, 1, 2 and 4. The Intervention Fragments are re-ordered with 5 appearing first, followed by 1, 2 and 4.

The Watchdog Processor according to the Watchdog Rules revises the Intervention. Watchdog Rules dictate that persons only receive Intervention No. 1 once within 30 days and never again if the person of interest provides answers. Watchdog Rules dictate that persons only receive Intervention No. 2 once within 30 days and never again if the person of interest provides answers. Watchdog Rules dictate that persons of interest only receive Intervention NO. 4 once within 30 days. Given these watchdog rules, Interventions No. 1, 2 and 4 are eliminated from the communication.

The communication is revised to include only Intervention Fragment 5 and readied for distribution to John Stone.

Over time, the system will continue to build upon itself by adding new purchase or other customer history information. Each time a new data point is received; the system is re-initiated and begins again the processing: reviewing the person's data, matching lifecycles to the persons, matching intervention/fragments to the lifecycles, assembling the interventions, scheduling the intervention, and finalizing the communication.

### Second Illustration: In Action for an Automotive Company

This system is unique in the combination and uses of the data in order to create personalized, individualized surveys and communications (called Interventions). In existing systems, one or two pieces of data might be combined in order to create limited, segmented communications. In this system, many more data pieces are combined in unique combinations to create an individualized approach. In an example embodiment, Great Automotive uses the system to create an ongoing dialogue with people who complete a follow-up form on their web site, which indicates an interest in purchasing one of Great Automotive's vehicles. The Customer Data History module has the following data “facts” about a certain person of interest:

Name: Jane Stone

Female

Age 61

Completed a web form indicating:
a. Interest in Great Automotive's new car model: The Hero
b. Reasons for considering a purchase: Existing vehicle has more than 150,000 miles
c. Household already owns another Great Automotive model, The Stetson, a full-sized truck
d. Household purchased The Stetson truck more than 3 years ago but less than 5 years ago from Great Automotive at 123 Main Street
e. Preferred local Great Automotive Dealership location: Great Automotive at 123 Main Street

Great Automotive deploys the systems and methods herein in order to create an ongoing dialogue with its customers, including Jane Stone. The system includes a plurality of rules governing the assignment of lifecycles to each person of interest, such as Jane Stone. Each rule uses one or more data facts to assign persons to lifecycles. For example:
Persons who have purchased a vehicle from Great Automotive are identified as Great Automotive Customers
Persons who have purchased The Stetson are identified as Stetson Owners
Persons who have indicated interest in any Great Automotive model via an online form are identified as Web Lead
Persons who have indicated interest in The Hero model via an online form are identified as Hero—Web Lead

Each lifecycle is associated with certain Intervention Fragments. Jane Stone's lifecycle assignments result in the following list of Intervention Fragments being prescribed for her:

A 6-question survey to learn more about Jane Stone's interest in The Hero is prescribed. This is prescribed because Jane Stone's customer “facts” meet the following Intervention Trigger rules:
a. Lifecycle: Hero-Web Lead

A 2-question survey to learn how Jane Stone would like to be contacted in the future by Great Automotive at 123 Main Street is prescribed. This is prescribed because Jane Stone's customer “facts” meet the following Intervention Trigger rules:
a. Lifecycle: Web lead, and
b. Preferred local Great Automotive Dealership location: Great Automotive at 123 Main Street

A coupon for Free Washing/Detailing/Waxing of Stetson vehicles at Great Automotive at 123 Main Street is prescribed. This is prescribed because Jane Stone's customer “facts” meet the following Intervention Trigger rules:
a. Lifecycle: Great Automotive Customer,
b. Lifecycle: Web Lead,
c. Stetson Owner, and
d. Preferred local Great Automotive Dealership location: Great Automotive at 123 Main Street

A 5-question survey to learn about the use and satisfaction with the Stetson is prescribed. This is prescribed because Jane Stone's customer “facts” meet the following Intervention Trigger rules:
a. Lifecycle: Great Automotive Customer,
b. Lifecycle: Stetson Owner, and
c. Owned Stetson for >3 years

The Assembler Rules dictate the inclusion and ordering of Intervention Fragments. Rules dictate that:
Intervention NO. 4 cannot appear with intervention NO. 1. Intervention No. 1 is prioritized above Intervention Fragment No. 4.
Intervention Fragment No. 1 appears first.
Intervention Fragment No. 2 appears second.
Intervention Fragment No. 3 appears last.

Given the above rules, the Assembler Rule Processor sorts, eliminates as needed and orders the communication for sending to the person of interest. Jane Stone's communication is revised to include only Intervention Fragments 1, 2 and 3. The Intervention Fragments are ordered as 1, 2 and 3.

The Watchdog Processor according to the Watchdog Rules reviews the Intervention. Watchdog Rules dictate that persons only receive Intervention No. 1 once within 30 days and never again if the person of interest provides answers. Watchdog Rules dictate that persons only receive Intervention No. 2 once within 30 days and never again if the person of interest provides answers. Watchdog Rules dictate that persons of interest only receive Intervention No. 3 once within 30 days. Given that this is the first communication sent to Jane Stone, all of the Intervention Fragments conform to the Watchdog Rules. The communication is, thus, readied for distribution to Jane Stone.

The next day (12 hours after the communication was distributed), the Customer History Module recognizes the receipt of new data about Jane Stone. The following new facts are available:
Jane Stone's household consists of 2 adults and 3 children.
Jane Stones identifies three criteria in deciding what vehicle to buy: Towing capacity, gas mileage and Latch system/child safety features
Jane Stone will use the vehicle to tow boats and recreational vehicles
Jane Stone plans to purchase a vehicle within the next 7-10 days
Jane Stone plans to finance the vehicle purchase through the financing options offered by the dealership and Great Automotive Company
Jane Stone prefers to be contacted by Great Automotive at 123 Main Street by phone and provides her phone number
Jane Stone wants to set up a test drive

Upon receipt of the new data, the system automatically reviews the totality of data in order to assign Jane Stone to the configured Lifecycle Categories. The system identifies Jane Stone as being part of the following Lifecycles:
Persons who have purchased a vehicle from Great Automotive are identified as Great Automotive Customers
Persons who have purchased The Stetson are identified as Stetson Owners
Persons who have indicated interest in any Great Automotive model via an online form are identified as Web Lead
Persons who have indicated interest in The Hero model via an online form are identified as Hero—Web Lead

Each lifecycle is associated with certain Intervention Fragments. Jane Stone's lifecycle assignments result in the following list of Intervention Fragments being prescribed for her:

A coupon for Free Washing/Detailing/Waxing of Stetson vehicles at Great Automotive at 123 Main Street is prescribed. This is prescribed because Jane Stone's customer “facts” meet the following Intervention Trigger rules:
a. Lifecycle: Great Automotive Customer,
b. Lifecycle: Web Lead,
c. Stetson Owner, and
d. Preferred local Great Automotive Dealership location: Great Automotive at 123 Main Street

A 5-question survey to learn about the use and satisfaction with the Stetson is prescribed. This is prescribed because Jane Stone's customer “facts” meet the following Intervention Trigger rules:
e. Lifecycle: Great Automotive Customer,
f. Lifecycle: Stetson Owner, and
g. Owned Stetson for >3 years

Email marketing message comparing how The Hero model compares to other models in its class on Towing Capacity is prescribed. This is prescribed because Jane Stone's customer “facts” meet the following Intervention Trigger rules:
h. Lifecycle: Hero Web Lead, and
i. Decision-making criteria: Towing Capacity

Email marketing message comparing how The Hero model compares to other models in its class on Gas Mileage is prescribed. This is prescribed because Jane Stone's customer “facts” meet the following Intervention Trigger rules:
j. Lifecycle: Hero Web Lead, and
k. Decision-making criteria: Gas Mileage

Email marketing message comparing how The Hero model compares to other models in its class on child safety features is prescribed. This is prescribed because Jane Stone's customer “facts” meet the following Intervention Trigger rules:
l. Lifecycle: Hero Web Lead, and
m. Decision-making criteria: Latch system/child safety features

Phone call from dealership sales person to schedule a test drive of the Hero is prescribed. This is prescribed because Jane Stone's customer “facts” meet the following Intervention Trigger rules:
n. Lifecycle: Hero Web Lead,
o. Preferred contact method for dealership contact is phone,
p. Jane Stone wants to schedule a test drive

The Assembler Rules dictate the inclusion and ordering of Intervention Fragments. Rules dictate that:
Intervention No. 6 cannot be combined with any other Intervention.
Intervention No. 3, 4 and 5 can be combined with each other but cannot be combined with any other interventions.
Intervention No. 1 can only be distributed once in 30 days. Jane Stone received this Intervention just a couple of days ago.

Given the above rules, the Assembler Rule Processor sorts, eliminates as needed and orders the communication for sending to the person of interest. Intervention No. 6 is separated from the others and scheduled for separate processing, as this one is a phone call vs. an email communication.

The Watchdog Processor reviews the finalized Interventions. These conform to all existing Watchdog Rules and are scheduled for distribution.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

What is claimed is:

1. A system for use by a client to obtain information from persons of interest, the system comprising:
A processor;
A person of interest (POI) database of facts relating to each POI of the client;
A lifecycle database of various lifecycles of a plurality of POIs, a plurality of products and a plurality of services wherein each lifecycle is defined by and includes one or more facts;
A intervention fragments database of fragments of communication content elements;
An intervention engine including computer executable instructions stored on a tangible, non-transitory memory device and executed by the processor, wherein the instructions evaluate the facts in the POI database and the lifecycles in the lifecycle database to identify fragments in the intervention fragments database to form a customized, individualized communication to be provided to a specific POI, which customized, individualized communication is related to the facts of the POI and the lifecycle(s) which relate to the POI; and
A schedule engine to selectively initiate a point in time to provide the customized individualized communication to the specific POI based on the evaluation by the intervention engine.

2. The system of claim 1 wherein the POI database includes:
facts based on POI data available to the client;
facts based on POI data provided by the POI in response to previous contacts;
facts based on product/services data of products/services purchased or used by the POI; and
facts based on POI data from transactions relating to the POI and/or products or services connected to the POI.

3. The system of claim 1 wherein the processor continuously monitors and evaluates the facts and lifecycles of each POI and updates changes in the facts and lifecycles and wherein the updated facts and lifecycles are evaluated by the intervention engine and the schedule engine.

4. The system of claim 1 further comprising a lifecycle rules engine including computer executable instructions stored on a tangible, non-transitory memory device and executed by the processor, wherein the lifecycle rules instructions evaluate initiating fact which signal the beginning of a lifecycle, wherein the lifecycle rules instructions evaluate facts which modify or enrich a lifecycle, and wherein the lifecycle rules instructions evaluate facts indicate a termination of the lifecycle.

5. The system of claim 1 wherein the intervention engine comprises:
A trigger rules engine including computer executable instructions stored on a tangible, non-transitory memory device and executed by the processor, wherein each fact of each lifecycle of a POI is related to an intervention fragment, and wherein the trigger rules engine instructions determine lifecycle assignments of each POI and determine facts about each POI to be combined to define intervention fragments to be contained in future interventions with each POI; and
An assembler rules engine including computer executable instructions stored on a tangible, non-transitory memory device and executed by the processor, wherein the assembler rules engine instructions assemble interventions comprising one or more intervention fragments.

6. The system of claim 3 wherein the customized, individualized communication is based on facts and lifecycles of each POI within the context of marketing intervention parameters suggested by the facts and the lifecycles of each POI.

7. The system of claim 1 wherein the schedule engine comprises rules for implementing communications at predefined times based on rules and based on one or more of: facts, lifecycles, and intervention fragments of the POI.

8. The system of claim 1 further comprising a watchdog rules engine including computer executable instructions stored on a tangible, non-transitory memory device and executed by the processor, wherein the watchdog rules engine instructions for evaluating and finalizing communications content based on pre-set limitations specified by a plurality of watchdog business rules.

9. The system of claim 8 wherein the watchdog engine eliminates intervention fragments to conform to the watchdog business rules.

10. The system of claim 1 wherein the processor runs autonomously without input from external sources based on:
feedback provided by POI used to generate future interventions; and
reviewing all known data about a POI, matching the POI data to the lifecycle facts and then matching the lifecycle facts to the intervention fragments wherein the intervention fragments are then evaluated against configured business rules, selected for inclusion and ordered into an individualized communication for each person of interest.

11. The system of claim 10 wherein the processor continues to run until the POI data no longer meets guidelines for any of the lifecycles and intervention fragments.

12. A computer executable method executable by a processor for use by a client to obtain information from persons of interest, the method for use with:
A person of interest (POI) database of facts relating to each POI of the client;
A lifecycle database of various lifecycles of a plurality of POIs, a plurality of products and a plurality of services wherein each lifecycle is defined by and includes one or more facts; and
A intervention fragments database of fragments of communication content elements; the method comprising:
intervention engine computer executable instructions stored on a tangible, non-transitory memory device and executed by the processor, wherein the instructions evaluate the facts in the POI database and the lifecycles in the lifecycle database to identify fragments in the intervention fragments database to form a customized, individualized communication to be provided to a specific POI, which customized, individualized communication is related to the facts of the POI and the lifecycle(s) which relate to the POI; and
schedule engine computer executable instructions stored on a tangible, non-transitory memory device and executed by the processor, wherein the instructions selectively initiate a point in time to provide the customized, individualized communication to the specific POI based on the evaluation by the intervention engine.

13. The method of claim 12 wherein the POI database includes:
facts based on POI data available to the client;
facts based on POI data provided by the POI in response to previous contacts;
facts based on product/services data of products/services purchased or used by the POI; and
facts based on POI data from transactions relating to the POI and/or products or services connected to the POI.
And wherein the processor continuously monitors and evaluates the facts and lifecycles of each POI and updates changes in the facts and lifecycles and wherein the intervention engine and the schedule engine evaluate the updated facts and lifecycles.

14. The method of claim 12 further comprising a lifecycle rules engine including computer executable instructions stored on a tangible, non-transitory memory device and executed by the processor, wherein the lifecycle rules instructions evaluate initiating fact which signal the beginning of a lifecycle, wherein the lifecycle rules instructions evaluate facts which modify or enrich a lifecycle, and wherein the lifecycle rules instructions evaluate facts indicate a termination of the lifecycle.

15. The method of claim 12 wherein the intervention engine instructions comprises:
trigger rules engine computer executable instructions stored on a tangible, non-transitory memory device and executed by the processor, wherein each fact of each lifecycle of a POI is related to an intervention fragment, and wherein the trigger rules engine instructions determine lifecycle assignments of each POI and determine facts about each POI to be combined to define intervention fragments to be contained in future interventions with each POI; and
assembler rules engine computer executable instructions stored on a tangible, non-transitory memory device and executed by the processor, wherein the assembler rules engine instructions assemble interventions comprising one or more intervention fragments.

16. The method of claim 15 wherein the customized, individualized communication is based on facts and lifecycles of each POI within the context of marketing intervention parameters suggested by the facts and the lifecycles of each POI.

17. The method of claim 12 wherein the schedule engine instructions comprises rules instructions for implementing communications at predefined times based on rules and based on one or more of: facts, lifecycles, and intervention fragments of the POI.

18. The method of claim 12 further comprising watchdog rules engine computer executable instructions stored on a tangible, non-transitory memory device and executed by the processor, wherein the watchdog rules engine instructions for evaluating and finalizing communications content based on pre-set limitations specified by a plurality of watchdog business rules.

19. The method of claim 18 wherein the watchdog engine instructions eliminates intervention fragments to conform to the watchdog business rules.

20. The method of claim 12 wherein the processor runs autonomously without input from external sources based on:
Feedback provided by POI used to generate future interventions; and reviewing all known data about a POI, matching the POI data to the lifecycle facts and then matching the lifecycle facts to the intervention fragments wherein the intervention fragments are then evaluated against configured business rules, selected for inclusion and ordered into an individualized communication for each person of interest.

21. The method of claim 20 wherein the processor continues to run until the POI data no longer meets guidelines for any of the lifecycles and intervention fragments.
